(19) United States
(12) Patent Application Publication
(10) Pub. No.: US 2017/0099626 A1
(43) Pub. Date: Apr. 6, 2017

(54) SYSTEMS AND METHODS FOR IDENTIFYING WIRELESS SERVICE OPPORTUNITIES

(71) Applicant: Level 3 Communications, LLC, Broomfield, CO (US)

(72) Inventor: Ryan T. Privette, Denver, CO (US)

(73) Assignee: Level 3 Communications, LLC, Broomfield, CO (US)

(21) Appl. No.: 15/282,702

(22) Filed: Sep. 30, 2016

Related U.S. Application Data
(60) Provisional application No. 62/236,748, filed on Oct. 2, 2015.

(51) Int. Cl. H04W 48/08; H04L 12/26

(52) U.S. Cl. CPC H04W 48/08; H04L 43/06; H04W 64/006

(57) ABSTRACT

Aspects of the present disclosure involve a system and method for identifying wireless service opportunities. The system identifies available wireless service opportunities for use as a backup network. The identified wireless services can be presented via an output report using a graphical user interface (GUI). Wireless opportunities can be identified by communicating with servers that provide information regarding services available in a region of interest. The information gathered can include various metrics including network types, signal strength, and throughput.

### CROSS-REFERENCE TO RELATED APPLICATION

This application is related to and claims priority under 35 U.S.C. §119(e) from U.S. Patent Application No. 62/236,748, filed Oct. 2, 2015 entitled “SYSTEMS AND METHODS FOR IDENTIFYING WIRELESS SERVICE OPPORTUNITIES,” the entire contents of which is incorporated herein by reference for all purposes.

### FIELD

This disclosure relates generally to identifying available wireless services. The disclosure further relates to using the identified available wireless services for backup selection in instances where a network outage may occur or otherwise redundancy may be needed.

### BACKGROUND

The constant demand to be connected for communicating, transacting, and conducting business requires a reliable network. However, networks may encounter outages, which may leave a business at a standstill and without a backup. A backup network should be reliable and easily accessible.

### SUMMARY

A system includes a computing device that selects a backup network from a list of available networks at a particular location and transitions from a network with an outage to the backup network. Briefly described, and according to one embodiment, aspects of the present disclosure generally relate to systems and methods for obtaining a representation of a particular location, requesting the list of available networks at the particular location, and selecting a particular network from the list of networks to provide backup network service at the particular location.

According to one embodiment, a system includes a processor and a non-transitory computer-readable medium storing instructions that, when executed by the processor, cause the processor to perform operations including receiving a representation of a physical location, transmitting the representation of the physical location to a server, receiving from the server, a list of networks that provide service at the physical location based on the representation of the physical location, receiving a selection of a particular network from the list of networks based on a metric, and establishing a failover to the particular network at the physical location.

According to a further embodiment, a method includes receiving, by a processor, a first representation of a physical location, transmitting, by the processor, the first representation of the physical location, receiving, by the processor, a second representation of the physical location that corresponds with the first representation of the physical location, transmitting, by the processor, the second representation of the physical location to a server, receiving, by the processor, from the server, a list of cellular networks that provide service at the physical location based on the second representation of the physical location, receiving, by the processor, a selection of a particular network from the list of cellular networks, and establishing, by the processor, a failover from a primary network with a network outage to the particular network at the physical location.

According to another embodiment, a non-transitory computer-readable medium includes instructions stored thereon that, when executed by a processor, cause the processor to perform operations including receiving a first representation of a physical location, transmitting the first representation of the physical location, receiving a second representation of the physical location that corresponds with the first representation of the physical location, transmitting the second representation of the physical location to a server, receiving from the server, a list of cellular networks that provide service at the physical location based on the second representation of the physical location, receiving a selection of a particular network from the list of cellular networks, and establishing a failover from a primary network with a network outage to the particular network at the physical location.

These and other aspects, features, and benefits of the present disclosure will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

FIG. 1 is a diagram illustrating a system for identifying available backup wireless services according to an example embodiment.

FIG. 2 is a block diagram of a client computing device of the system according to an example embodiment.

FIG. 3 is flowchart of a process for identifying available backup wireless services for a location of interest according to an example embodiment.

FIG. 4 is a diagram illustrating a graphical user interface of an application showing a backup report illustrating available backup wireless services with tunable metrics according to an example embodiment.

FIG. 5 is a diagram illustrating an example of a computer system which may be used in implementing embodiments of the present disclosure.

### DETAILED DESCRIPTION

Aspects of the present disclosure involve systems, methods, and devices for identifying wireless service opportunities for a specific geographic location of interest. As an example, the specific geographic location of interest may be a location where a user desires to establish a backup wireless network service such as a cellular network to provide network services in the event of a primary network outage. While the backup network is not limited to a wireless network, a wireless network may be provisioned quicker than a wired network in the event of an outage, limiting downtime. In one embodiment, wireless service opportunities are identified and presented via an output report using a graphical user interface (GUI). In another embodiment, a system may determine the identified wireless opportunity and automatically place an order for the hardware and/or software required to establish and provision a backup network at the location of interest before an outage of the primary network occurs. As a result, when a primary network is unavailable, the system may transition to the backup network service. Wireless opportunities can be identified by communicating with web services providing information about the services available in a region of interest. The information gathered can include not only the wireless service opportunities available in a geographical location, but other metrics as well, including signal strength, throughput, and other parametric data. The output report can be tailored to summarize the wireless opportunities and can be presented at least based in part on a specified business need. The parametric data presented in the output report can be used to determine the wireless service available, the quality of the service, and whether it is sufficient for a redundant or parallel service.

For example, a grocery store may use a first network, e.g., a primary network, to process customer purchases. However, as is the case with networks in general, a network outage can occur. In such an instance, a second network, e.g., a backup wireless service, can be utilized to complete customer transactions in the event of such an outage. To determine what backup wireless service to utilize, a method and system for identifying the wireless services available is provided herein.

A client computing device may communicate with a location server computing device and a network server computing device using a communications network. The client computing device may send a representation of a physical address to the network server computing device and receive a list of available wireless service opportunities at the physical address. The client computing device may display a graphical user interface to allow a user to view backup network information associated with the list of wireless service opportunities and select a backup network to provide services for the particular location in the event of a network outage for a primary network.

The client computing device and the server computing devices communicate using Hypertext Transfer Protocol (HTTP) and/or other communications protocols. HTTP provides a request-response protocol in the client-server computing model. An application running on the client computing device may be a client and an application running on the server computing device may be the server, e.g., a web server. The client submits an HTTP request to the server. The server computing device provides resources including Hypertext Markup Language (HTML) files and other content, and performs other functions on behalf of the client, and returns a response message to the client.

As an example, the location server computing device receives the HTTP request from the client computing device to determine geographic coordinates for a particular address by geocoding the particular address. The location server computing device may return a response message to the client computing device. The network server computing device receives the HTTP request from the client computing device to determine backup network information for a particular area associated with the geographic coordinates by querying a database. The network server computing device may return a response message indicating backup network information for the particular area associated with the geographic coordinates to the client computing device that may be parsed. Information parsed from the response message may be displayed by an application to visually indicate the backup network information for the particular area associated with the geographic coordinates. A backup network may be selected, provisioned, and utilized in the event of a primary network outage.

The computing devices may communicate based on representational state transfer (REST) and/or Simple Object Access Protocol (SOAP). As an example, a first computer (e.g., the client computing device) may send a request message that is a REST and/or a SOAP request formatted using Javascript Object Notation (JSON) and/or Extensible Markup Language (XML). In response to the request message, a second computer (e.g., the location server computing device or the network server computing device) may transmit a REST and/or SOAP response formatted using JSON and/or XML.

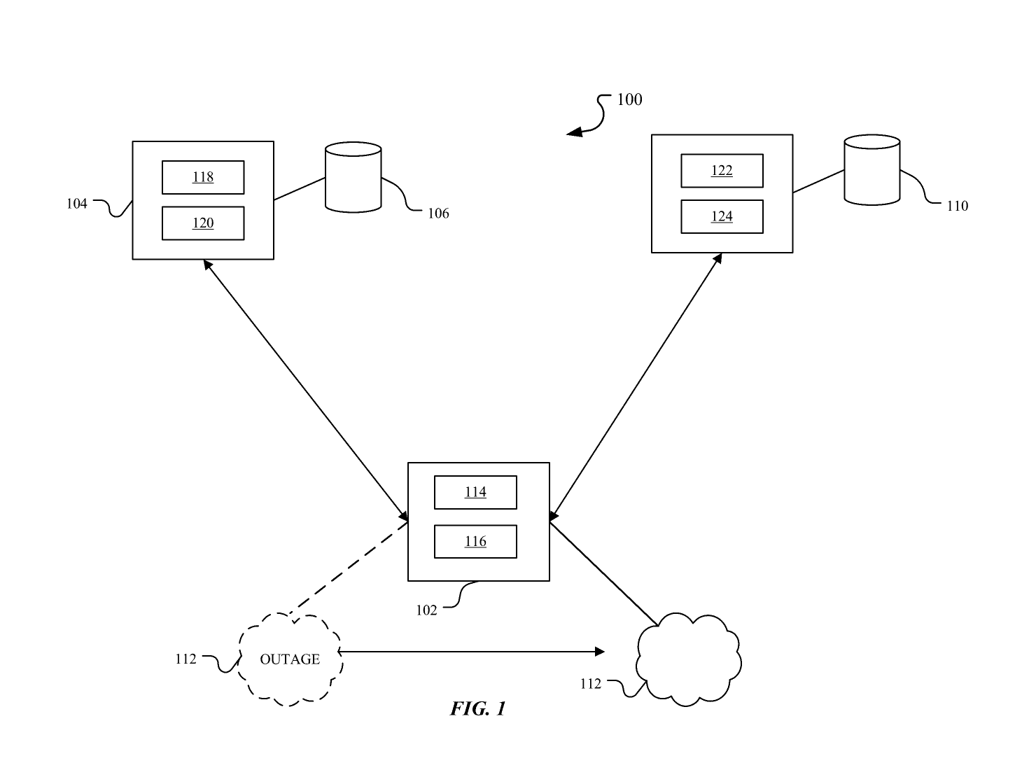

FIG. 1 illustrates a block diagram of a backup network system 100 that may be used for identifying available networks according to an example embodiment. The backup network system 100 includes computing devices that perform a method for determining parametric data regarding wireless services available at a location of interest. According to an aspect of the present disclosure, the backup network system 100 includes a client computing device 102. The backup network system 100 further comprises a location server computing device 104 having a location database 106 and a network server computing device 108 having a network database 110. Alternatively, the location server computing device 104 and the network server computing device 108 may be a single computing device. In addition, the location database 106 and the network database 110 may be a single database.

The location database 106 may be a repository of coordinates corresponding to (standard inputs) (e.g., physical addresses). The repository may include data from geographic data sets and mapping data sources. Additionally or alternatively, the location database 106 can include corresponding regions that provide a perimeter around the location of interest (e.g., physical address). For example, a street address may be provided to the location server computing device 104 which can obtain the latitude and longitude coordinates for the address.

The network database 110 can be accessed and queried to determine information regarding a location of interest. Specifically, the network server computing device 108 can use the coordinate information and/or bounded region information from the location server computing device 104 to provide statistical information about the specified physical address. For example, the network database 110 may be a wireless services database which can include information including network type (e.g., GSM/EDGE, 3G, 4G, and 5G), available carriers (e.g., Sprint, Verizon, AT&T, etc.), received signal strength indicator (RSSI) levels, and data throughputs associated with the specified physical address. The information stored in the network database 110 can be provided by organizations collecting data, via crowdsourcing, and/or using dedicated devices that collect network data such as other wired and/or wireless devices.

The client computing device 102 may communicate with the location server computing device 104 and the network server computing device 108 using web Application Programming interfaces (APIs). Web APIs are a set of instructions, routines, standards, and protocols that can be used to access web based applications, services, or tools. For example, the location server computing device 104 and/or the network server computing device 108 may provide web APIs that provide output coordinate and service information and can be accessed via the client computing device 102. As another example, the network server computing device 108 can be part of a system provided by the carriers (e.g., Sprint, AT&T, Verizon, T-Mobile, etc.) with direct access to the carrier's wireless services information. The service information can be used to determine and identify a redundant service that may be used by a consumer if an outage occurs or a parallel service is desired. For example, numerous devices may be connected to a primary network—smartphones, tablets, servers, personal computers and the like. In the example case of a grocery store, point of sale computing devices, e.g., cash registers, may connect to the primary network to process electronic transactions including credit or debit card transactions. The primary network may suffer an outage or network integrity may be jeopardized by a variety of factors. The system 100 can be used to identify and obtain a suitable backup connection before the network outage occurs (e.g., a cellular network such as a 3G network and/or a 4G network). For example, if the primary network connection becomes unavailable at the grocery store, transactions may still be processed using the backup connection.

To determine a suitable backup connection to be setup before the network outage occurs, the client computing device 102 can communicate with the location server computing device 104 and/or the network server computing device 108 to obtain parametric data about the location. The client computing device 102 may utilize various rules to select an appropriate back up service for any given location. For example, it is possible that that a service level agreement (SLA) may be in place that specifies a minimum signal strength for a backup connection. It is also possible that a price point or wireless provider may be required or preferred. It is also possible that a service type (e.g., 3G versus 4G) may be preferred. Thus, the service information and parametric data may be analyzed by a set of rules to determine a suitable backup network for a given location. Such options may be ranked or may be automatically chosen and passed to a network provider for ordering and provisioning before the network outage occurs.

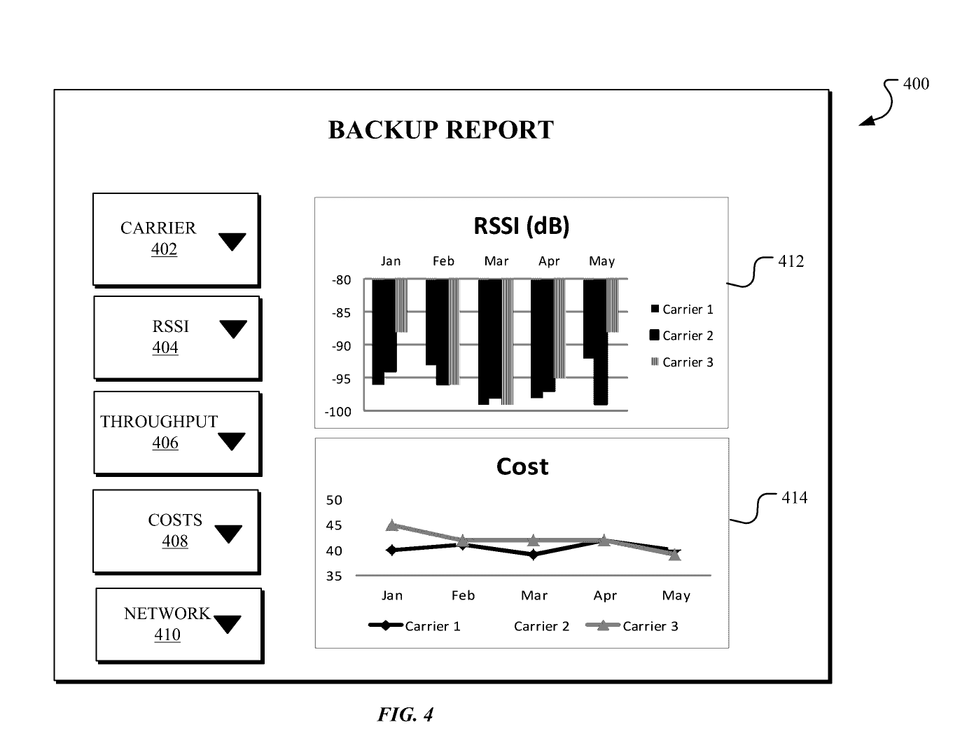

In a real time consumer oriented implementation, an outage detection module associated with the client computing device 102 can be used to detect a failure on the primary network. When a failure occurs, the client computing device 102 can transition to backup wireless services available at the current location. For example, an outage can occur and be detected by the outage detection module. To setup and preconfigure a backup network in case of a network failure, a user of the client computing device 102 can enter a standard input (e.g., physical address) of the location into an application executed by the client computing device or another computing device. The application can then communicate with the location server computing device 104, which can translate the address provided into corresponding coordinates. Next, the location server computing device 104 can communicate directly with the network server computing device 108 and/or the client computing device 102. The coordinates and a corresponding bounding area can be sent to the network server computing device 108. The network server computing device 108 may retrieve network information including available backup networks associated with the address. Once the network information is received, the application can determine a preferred backup network for selection. The backup network may be selected based on rules and/or metrics that may be user adjustable. For example, the client computing device 102 or another computing device can present the network information visually. FIG. 4 provides an exemplary illustration of a Graphical User Interface (GUI) used to provide parametric wireless services data in a backup report type display.

When a backup network is provisioned at a location and when an outage occurs, the outage may be detected and the system 100 may prompt a switch to traffic network data over the backup network.

The computing devices communicate and coordinate their actions by passing messages over a communication network 112. The communication network 112 used to setup the backup network can be the primary network before the outage occurs or another communication network. The communication network 112 can be one or more of the Internet, an intranet, a cellular communications network, a WiFi network, a packet network, or another wired or wireless communication network. As an example, the computing devices communicate data in packets, messages, or other communications using a common protocol, e.g., HTTP and/or Hypertext Transfer Protocol Secure (HTTPS). As an example, the backup network system 100 may be a cloud-based computer system or a distributed computer system.

The location database 106 comprises an organized collection of data. The data in the location database 106 may include one or more tables including geographic coordinate information (latitude/longitude) for locations throughout the United States and other locations throughout the world. The network database 110 comprises an organized collection of data. The data in the network database 110 may include one or more tables including network information including network availability and network quality information for locations throughout the United States and other locations throughout the world.

The information may be stored in a non-relational database and/or in a relational database. As an example, the information may be stored in a database that is a collection of information that may be organized as one or more tables that may be accessed, managed, and updated. The information may be stored in a relational database management system (RDBMS), an open source distributed database management system such as a Not only SQL (NoSQL) database management system, an in-memory database (IMIDB) management system, or another appropriate database management system.

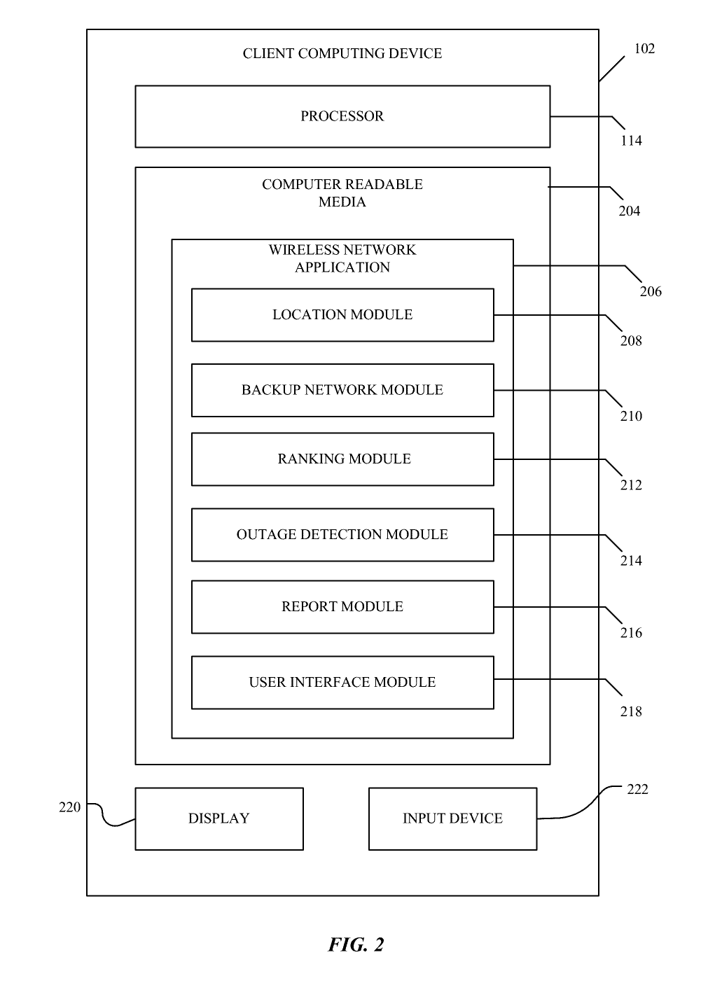

FIGS. 1 and 2 illustrate a block diagram of the client computing device 102 according to an example embodiment. The client computing device 102 may be a computer having a processor 114 and memory 116, including but not limited to a laptop, desktop, tablet computer, mobile computing device (e.g., a smartphone) or a dedicated electronic device having a processor and memory. The processor 114 may process machine/computer-readable executable instructions and data, and the memory 116 may store machine/computer-readable executable instructions and data including applications, including a wireless network application 206. The processor 114 and memory 116 are hardware. The memory 116 includes random access memory (RAM) and non-transitory memory, e.g., a non-transitory computer-readable medium such as flash disks or hard drives. The non-transitory memory may include any tangible computer-readable medium including, for example, magnetic and/or optical disks, flash drives, and the like. Additionally, the memory 116 may also include a dedicated file server having a dedicated processor, random access memory (RAM), a Redundant Array of Inexpensive/Independent Disks (RAID) hard drive configuration, and an Ethernet interface or other communication interface, among other components.

The client computing device 102 further includes a display 220 and an input device 222. The display 220 is used to display visual components of the wireless network application 206, such as at a user interface. In one example, the user interface may display a user interface of the wireless network application. The display 220 can include a cathode-ray tube display, a liquid-crystal display, a light-emitting diode display, a touch screen display, and other displays. The input device 222 is used to interact with the wireless network application 206 and may include a mouse, a keyboard, a trackpad, and/or the like. The input device 222 may be included within the display 220 if the display is a touch screen display. The input device 222 allows a user of the client computing device 102 to manipulate the user interface of the wireless network application 206.

FIG. 1 illustrates a block diagram of the location server computing device 104 according to an example embodiment. The location server computing device 104 may be a computer having a processor 118 and memory 120, including but not limited to a server, a laptop, desktop, tablet computer, mobile computing device (e.g., a smartphone) or a dedicated electronic device having a processor and memory. The processor 118 may process machine/computer-readable executable instructions and data, and the memory 120 may store machine/computer-readable executable instructions and data including applications. The processor 118 and memory 120 are hardware. The memory 120 includes random access memory (RAM) and non-transitory memory, e.g., a non-transitory computer-readable medium such as flash disks or hard drives. The non-transitory memory may include any tangible computer-readable medium including, for example, magnetic and/or optical disks, flash drives, and the like. Additionally, the memory 120 may also include a dedicated file server having a dedicated processor, random access memory (RAM), a Redundant Array of Inexpensive/Independent Disks (RAID) hard drive configuration, and an Ethernet interface or other communication interface, among other components.

FIG. 1 illustrates a block diagram of the network server computing device 108 according to an example embodiment. The network server computing device 108 may be a computer having a processor 122 and memory 124, including but not limited to a server, a laptop, desktop, tablet computer, mobile computing device (e.g., a smartphone) or a dedicated electronic device having a processor and memory. The processor 122 may process machine/computer-readable executable instructions and data, and the memory 124 may store machine/computer-readable executable instructions and data including applications. The processor 122 and memory 124 are hardware. The memory 124 includes random access memory (RAM) and non-transitory memory, e.g., a non-transitory computer-readable medium such as flash disks or hard drives. The non-transitory memory may include any tangible computer-readable medium including, for example, magnetic and/or optical disks, flash drives, and the like. Additionally, the memory 124 may also include a dedicated file server having a dedicated processor, random access memory (RAM), a Redundant Array of Inexpensive/Independent Disks (RAID) hard drive configuration, and an Ethernet interface or other communication interface, among other components.

FIG. 2 illustrates a block diagram of the wireless network application 206 of the client computing device 102 according to an example embodiment. The client computing device 102 includes computer readable media (CRM) 204 on which the wireless network application 206 is stored. The computer readable media 204 may include volatile media, nonvolatile media, removable media, non-removable media, and/or another available medium that can be accessed by the processor 114. By way of example and not limitation, the computer readable media 204 comprises computer storage media and communication media. Computer storage media includes non-transitory memory, volatile media, nonvolatile media, removable media, and/or non-removable media implemented in a method or technology for storage of information, such as computer/machine-readable/executable instructions, data structures, program modules, or other data. Communication media may embody computer/machine-readable/executable instructions, data structures, program modules, or other data and include an information delivery media or system.

The wireless network application 206 includes a location module 208 for determining latitude and longitude information for a particular location. As an example, the location module 208 may receive a request from a user to obtain latitude and longitude information for a particular location and may transmit a request to the location server computing device 104. The location server computing device 104 may convert an address (e.g., a physical street address) into geographic coordinates. This is known as geocoding. The location server computing device 104 may receive the address from the location module 208 and query the location database 106 for latitude and longitude information. The location server computing device 104 may send a response to the location module 208 that provides the requested latitude and longitude information for the particular location.

In one example, the request from the user may include a physical address and the response may include a latitude and a longitude for the physical address. The location server computing device 104 may convert the physical address into geographic coordinates including the latitude and longitude by geocoding the physical address. In one example, the location server computing device 104 may geocode the physical address using the GOOGLE MAPS™ Geocoding API or another geocoding service. The location module 208 may send an address: “1600 Amphitheatre Parkway, Mountain View, Calif.” and request that the output from the location server computing device 104 be in JSON format. The location module 208 may send the following HTTP GET request to: https://maps.googleapis.com/maps/api/geocode/json?address=1600+Amphitheatre+Parkway,+Mountain+View+CA&key=MYAPIKEY. The MYAPIKEY is a server API key that is an authentication credential. To use the Google Maps Geocoding API, the requester must have a valid authentication credential. In response to the GET request, the location server computing device 104 may provide a JSON response similar to the following and the location module 208 may parse the response to determine that the latitude is 37.4224764 and the longitude is −122.0842499.

Example JSON Response:

{

“results” : [
{

“address_components” : [

```
{
  “long_name” : “1600”,
  “short_name” : “1600”,
  “types” : [ “street_number” ]
},
{
  “long_name” : “Amphitheatre Pkwy”,
  “short_name” : “Amphitheatre Pkwy”,
  “types” : [ “route” ]
},
{
  “long_name” : “Mountain View”,
  “short_name” : “Mountain View”,
  “types” : [ “locality”, “political” ]
},
{
  “long_name” : “Santa Clara County”,
  “short_name” : “Santa Clara County”,
  “types” : [ “administrative_area_level_2”, “political” ]
},
{
  “long_name” : “California”,
  “short_name” : “CA”,
  “types” : [ “administrative_area_level_1”, “political” ]
},
{
  “long_name” : “United States”,
  “short_name” : “US”,
  “types” : [ “country”, “political” ]
},
{
  “long_name” : “94043”,
  “short_name” : “94043”,
  “types” : [ “postal_code” ]
}
```

```
  ],
  “formatted_address” : “1600 Amphitheatre Parkway, Mountain View, CA 94043, USA”,
  “geometry” : {
```

```
“location” : {
  “lat” : 37.4224764,
  “lng” : −122.0842499
},
“location_type” : “ROOFTOP”,
“viewport” : {
  “northeast” : {
```

“lat” : 37.4238253802915,
“lng” : −122.0829009197085

```
  },
  “southwest” : {
```

“lat” : 37.4211274197085,
“lng” : −122.0855988802915

}
}

```
  },
  “place_id” : “ChIJ2eUgeAK6j4ARbn5u_wAGqWA”,
  “types” : [ “street_address” ]
}
```

```
  ],
  “status” : “OK”
```

}

The wireless network application 206 further includes a backup network module 210 for determining backup network information for the particular location. As an example, the backup network location module 210 may send a request to obtain backup network information based on the latitude and longitude information for the particular location. The backup network module 210 may send the request to the network server computing device 108. The network server computing device 108 may query the network location database 110 for backup network information and the network server computing device 108 may send a response to the backup network module 210 that provides the requested backup network information for the particular location. The network server computing device 108 may determine the backup network information by obtaining network statistics information for a particular area associated with the latitude and longitude obtained from the location server computing device 104. As an example, the area may be a geographic region such as a circular region that extends outward a particular radius from the latitude and longitude.

The geographical coordinates can be sent to a third party like OpenSignal™ specializing in wireless coverage mapping. In one example, the backup network module 210 may send an API request to OpenSignal and receive network statistics information in response to the API request. OpenSignal provides insight into coverage and performance of wireless networks worldwide. OpenSignal provides crowdsourced data carrier signal quality by obtaining consumer feedback from users that use the OpenSignal mobile application that monitors the coverage and performance of their mobile connection. The crowdsourced information collected is often provided by the user's own initiative and/or automatically collected (often anonymously) by their device using the mobile application. Alternatively, wireless service providers can also provide direct access to the network information where the parameters of interest (RSSI), throughput data, network type (e.g., 3G/4G), costs, etc., can be determined.

In one example, the backup network module 210 may send an HTTP GET request to: http://api.opensignal.com/v2/networkstats.json?lat=37.4224764&lng=--122.0842499&distance=1&json_format=2&network_type=3&apikey=MYAPIKEY. The MYAPIKEY is a server API key that is an authentication credential granted by OpenSignal and that has to be included with API requests. To use the OpenSignal API, the requester must have a valid authentication credential. The network server computing device 108 may provide a JSON response similar to the following and the backup network module 210 may parse the response to determine network statistics for a particular latitude and longitude. This example request provides averaged data for networks in a one kilometer by one kilometer geographical area around the Mountain View area.

Example JSON Response:

{

“apiVersion”: “2”,
“latitude”: “37.4224764”,
“longitude”: “−122.0842499”,
“distance”: “1”,
network_type: “3”,
“perMinuteCurrent”: 1,
“perMinuteLimit”: 5,
“perMonthCurrent”: 371,
“perMonthLimit”: 2000,
“networkRank”: [
{
“networkName”: “T-Mobile”,
“networkId”: “310260”,
“type3G”: {
“networkName”: “T-Mobile”,
“networkId”: “310260”,
“networkType”: “3”,
“averageRssiAsu”: “10.934899”,
“averageRssiDb”: “−91.130203”,
“sampleSizeRSSI”: “437532”,
“downloadSpeed”: “4532.8305”,
“uploadSpeed”: “1124.9649”,
“pingTime”: “148.8205”,
“reliability”: “94.5944170771741”
},
“type4G”: {
“networkName”: “EE”,
“networkId”: “23430”,
“networkType”: “4”,
“averageRsrpAsu”: “33.865632”,
“averageRsrpDb”: “−106. 134368”,
“sampleSizeRSRP”: “284041”,
“downloadSpeed”: “9851.1000”,
“uploadSpeed”: “4377.3200”,
“pingTime”: “87.0000”,
“reliability”: “96.2113095238094”

}

}

]
}

The wireless network application 206 further includes a ranking module 212 that may rank a list of backup networks based on the information obtained from the network server computing device 108. As an example, there may be five networks available at the particular location. The ranking module 212 may rank the five networks for the particular location based on criteria including RSSI, cost, carrier name, throughput, reliability, download speed, upload speed, and ping time, among others. As shown above, the average RSSI for the particular location may be provided in ASU (arbitrary strength unit) and in dBm (decibel-milliwatt). The average download speed is shown in Kbps (kilobits per second or thousands of bits per second), the average upload speed is shown in Kbps, the average ping time is shown in milliseconds, and the reliability is a percentage measured between 0 and 100. This reliability demonstrates a proportion of time that a data connection is available at the particular location. The highest ranked network or one of the five networks at the particular location may be selected to be the backup network at the particular location in the event of an outage of the primary network. The backup network may be setup and provisioned before such an outage occurs so that when the outage does occur, the system 100 transitions from the primary network to the backup network. In one example, the ranking module 212 may provide a user interface that allows a user to manually or automatically select and order the hardware and/or software to establish the preconfigured backup network at the location of interest. The backup network can be identified and selected by communicating with an external server that provides the network services. This external server may be the network server computing device 108 or another server such as a server associated with a network provider.

The wireless network application 206 further includes an outage detection module 214 that detects whether a primary network is unavailable for the client computing device 102 at the particular location or at another location. When an outage is detected, the preconfigured backup network is used to provide network services at the particular location. As an example, the preconfigured backup network may be the highest ranked backup network or one of the backup networks determined to be available at the particular location is used to provide network services for the client computing device 102 at the particular location. The outage detection module 214 may transition or reroute network traffic from the primary network with the network outage to the particular network. Thus, when the outage occurs, the outage detection module 214 may seamlessly transition from using the primary network to the selected network.

In another embodiment, a computing device separate from the client computing device 102 may execute a subset of the wireless network application 206 that includes the outage detection module 214. The computing device separate from the client computing device 102 may detect whether the primary network is unavailable for the client computing device 102 and may transition or reroute network traffic from the primary network with the network outage to the particular network.

The wireless network application 206 further includes a report module 216 that generates and provides reporting information for the backup networks based on the information obtained from the network server computing device 108. As an example, the reporting information may be displayed by the wireless network application as shown in FIG. 4. The reporting information may be stored in memory 116 such as the computer readable media 204 of the client computing device 102 or in another location as a file or data structure that is generated by the report module 216 and that may be sent to a particular recipient. Alternatively, the reporting information may be displayed by the client computing device 102 in a particular format on the display 220. The reporting information may be manipulated and interacted with by the user of the client computing device 102 using the input device 222.

The wireless network application 206 includes a user interface module 218. As an example, the user interface module 218 generates a native and/or web-based GUI that accepts input and provides output via the GUI. As an example, the GUI may provide information associated with the list of backup networks available at the particular location, the reporting information, and other information and receive selection of a particular backup network to deploy and use in the event of an outage that is detected at the particular location. An example of the GUI displaying the reporting information is shown in FIG. 4.

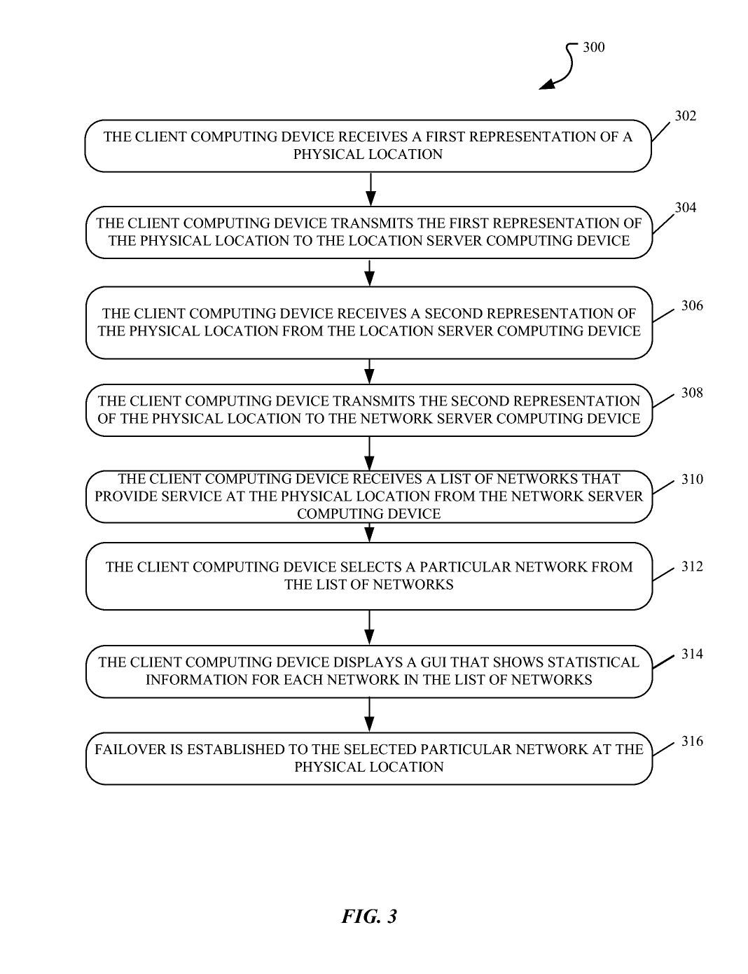

FIG. 3 is a flowchart of a process 300 for identifying wireless service opportunities available at a particular location. As indicated above, communication via a primary network at the particular location can be lost due to an outage requiring use of a backup network. In many instances, the outage may unpredictable and unpreventable. Provided the cost and downtime associated with repairing a wired network, a wireless backup network is most desirable. For example, cellular networks can be used for interconnectivity in the instance that a primary network may fail. Additionally or alternatively, other networks can be used such as Wireless Local Area Networks (WLAN), Wireless Personal Area Networks (WPAN), Wireless Metropolitan Area Networks (WMAN), mesh networks, etc. for use as a backup network. However, to determine what network to use as a backup, it is important to understand not only the networks available, but their performance and associated costs as well.

Process 300 provides a method for identifying the networks that are available at the particular location, as well as organizing and presenting the carrier performance for those networks in an organized manner (e.g., backup report provided by the wireless network application 206). The need for a backup network may be prompted by a detected outage or may be preemptive in order to prevent or provide network connectivity during a future outage. In this situation, a user or customer may want to prepare and understand the wireless service that provides the best service given their specific business needs. The process 300 shown in FIG. 3 begins at operation 302.

In 302, the client computing device 102 receives a first representation of a physical location. This first representation may be input provided by the client computing device 102, provided by a user, or another computing device, and may be a physical address.

For example, the input can be the common street address (e.g., 1234 Elm St., Denver, Colo. 80209 or 1600 Amphitheatre Parkway, Mountain View, Calif.) of a location of interest. The address may then be translated into a coordinate pair representation. The latitude/longitude coordinate pair enables the specification of any location on Earth. Thus, the common street address may be represented by its coordinate equivalent that allows communication between systems using universally understood values. Next, in 304, the client computing device 102 transmits the first representation of the physical location to the location server computing device 104. The location module 208 of the wireless network application 206 may transmit the first representation of the physical location to the location server computing device 104. The location server computing device 104 may query the location database 106 and may determine a second representation of the physical location, such as latitude and longitude for the physical location. The location server computing device 104 may transmit the second representation of the physical location to the client computing device 102.

In 306, the client computing device 102 receives a second representation of the physical location from the location server computing device 104. The location module 208 of the wireless network application 206 may receive the second representation of the physical location. Alternatively, the client computing device 102, e.g., the location module 208 of the application, may determine the second representation of the physical location.

In 308, the client computing device 102 transmits the second representation of the physical location to the network server computing device 108. The backup network module 210 of the wireless network application 206 may transmit the second representation of the physical location to the network server computing device 108. Alternatively, the backup network module 210 may transmit another representation of the physical location to the network server computing device 108, such as the first representation of the physical location. In addition to the geographical coordinates, e.g., the second representation of the physical location, a geographical bounded region or area can also be sent. The geographical bounded region provides a perimeter about the area of interest so that networks within that region can be determined. The size of the geographical bounded region can be pre-determined by the client computing device 102 and/or the network server computing device 108. The radius about the location of interest can vary based on the location of interest itself. For example, for the grocery store, a 0.5 kilometer radius may be selected or pre-determined to be sufficient. The network server computing device 108 determines a list of networks that provide service at the physical location and/or the geographical area using the network database 110 and transmits the list to the client computing device 102.

In 310, the client computing device 102 receives the list of networks that provide service at the physical location from the network server computing device 108. The backup network module 210 of the wireless network application 206 receives the list of networks and associated information. Alternatively, the client computing device 102 may determine the list of networks that provide service at the physical location.

In 312, the client computing device 102 selects a particular network from the list of networks. The ranking module 212 of the wireless network application 206 may rank the networks in the list of networks and select the particular network based on a ranking generated by the ranking module 212. The selection of the particular network may be automatic and based on a particular metric for the networks or may be manually provided as input by a user. As an example, the ranking module 212 may rank the five networks for the particular location and select a particular network based on criteria including RSSI, cost, carrier name, throughput, reliability, download speed, upload speed, and ping time, among others. The particular network selected may be based on an overall rating of the criteria for each network in the list of networks.

In 314, the client computing device displays a GUI that shows statistical information for each network in the list of networks. The report module 216 of the application may generate reporting information associated with the list of networks and the user interface module 218 of the application may display a GUI on the display 220 that provides the reporting information.

The GUI may include user interface elements that can take into account pre-determined criteria for presenting organized data in a report, via a portal, etc. The data processing can take into consideration parameters such as the criteria including preferred carrier, minimum RSSI, data integrity (minimum sample count), throughput, costs, and other aspects which can provide details regarding signal quality. The parameters can be adjusted based on the specific rules including business specific constraints.

The analyzed data may be used to generate a report by the report module 216 and/or to provide an output that may be displayed by the client computing device 102 and that can be used by the consumer so that an adequate backup wireless service may be selected. Additionally or alternatively, the output data can be saved to a file, a database, and a storage device, among others. Further, the output data can be processed automatically via a machine-to-machine interaction where the output drives a decision for ordering the backup wireless service and corresponding hardware. Thus, backup wireless network services may be ordered automatically based on the closest match identified between the parametric data received and the rules in the system that ensure the selected carrier meets any requirements. The automatic order can be driven based in part on feasibility. Still further, the output data can be sent to a computing device used by a technician if technical support is needed in order to utilize the backup network.

In 316, a failover is established to the selected particular network at the particular location. This may occur when an outage is detected by the client computing device 102 or another computing device. Network services at the particular location may transition from the primary network with the outage to the selected particular network at the particular location. The selected particular network may be a cellular network or another type of network.

FIG. 4 is a diagram illustrating a GUI 400 shown by the wireless network application 206. The GUI 400 may be generated by the report module 216, communicated to the user interface module 218, and show a backup report illustrating available backup wireless services with tunable metrics. The tunable metrics 402-410 illustrated can be selected for filtering and ranking the list of networks. The tunable metrics are for illustrative purposes and can include those presented in FIG. 4. However, there may be other metrics not shown in FIG. 4 or there may be less metrics than those shown in FIG. 4. The metrics shown in FIG. 4 each have an associated user interface element that the user may interact with and select using the input device 222. As an example, when one of the metrics is selected, FIG. 4 may display associated information via the GUI including graphs 412, 414.

For example, a tunable metric can be a carrier 402 which permits selection of a preferred wireless carrier (e.g., AT&T, T-Mobile, Verizon, etc.). Another tunable metric can include RSSI 404, which can provide an indication of the signal strength within the geographic bounded region. Similarly, the throughput 406 metric can also be selected, such that the available data throughput for the geographic bounded region is presented. Throughput data can provide details regarding the rate of successful message delivery over the wireless communication channel.

Costs 408 can also be selected if a specified price range is desired. Network 410 can be used for identifying a network preference. For example, the output report can be tuned to provide details regarding available carriers using 4G cellular networks and/or 3G cellular networks but with an RSSI above a given decibel value. Additional metrics can also be defined including the use of other network types outside the cellular network. The application and use of a backup wireless service is not limited to cellular and can be applicable to any and all other wired and wireless networks.

As the metrics of interest are selected, the graphical user interface 400 can be updated to provide the results in an organized manner. The data can be tabulated, a standard report can be presented, or a graphical representation, such as a graph, can be presented. In GUI 400, illustrative graphs 412, 414 of RSSI measurements and associated costs are presented. For example, graph 412 illustrates various signal strength measurements achieved over a time period extending for five months for three pre-selected carriers of interest. Using the RSSI graph 412, the appropriate wireless service with reliable signal strength can be selected. Additionally, graph 414 can be used to make a more informed selection. In graph 414, over the same time period and carrier selection, the costs are displayed. The costs in conjunction with the signal readings can provide adequate information for determining the wireless provider to use that best fits the business goals.

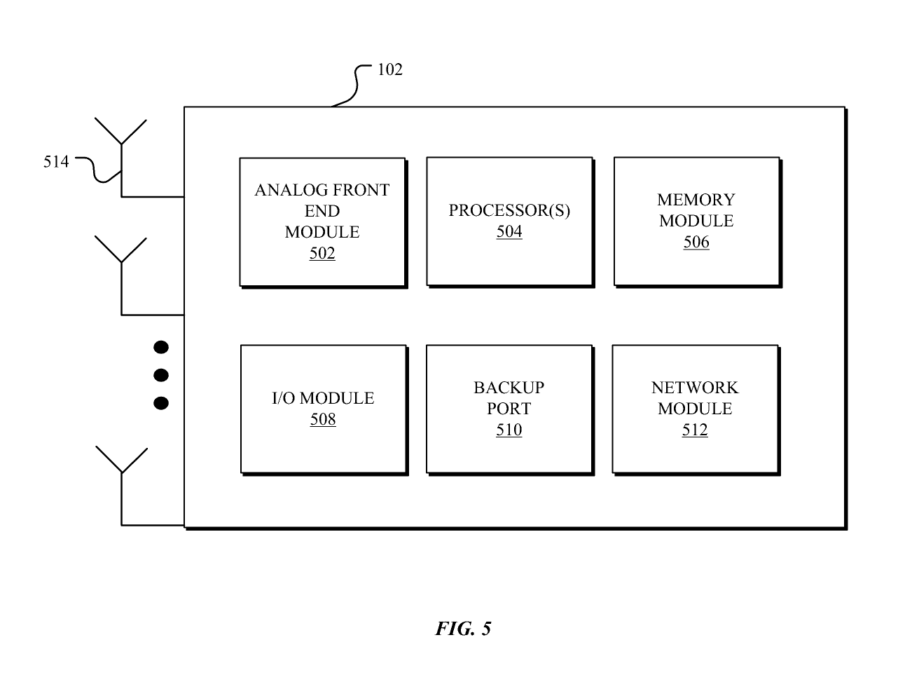

FIG. 5 is a block diagram of the client computing device 102 which can be used in implementing the embodiment of the present disclosure. The client computing device 102 can be any wired or wireless device capable of communicating over a network. For example, the client computing device 102 can be a desktop, a laptop, a mobile device, a tablet, or other similar communicating peripheral. Additionally or alternatively, the client computing device 102 can be a sub-system or portion of a larger computing system located within a larger device capable of locating wireless service opportunities. The client computing device 102 can include processor(s) 504.

The processor 504 can be coupled to at least a bus (not shown), controllers, memory and other modules. For example, the processor can communicate with a memory module 506 which can include memory cards, control circuits, etc. Memory module 506 can further include a dynamic storage device, random access memory (RAM), read only memory (ROM) and/or other static storage devices that can be used for storing temporary and long term variables and other intermediate information during the execution of instructions by the processors 504. The memory module 506 can also be used for storing and transmitting information in a form of a software or processing application (e.g., application 206) readable by the client computing device 102.

The client computing device 102 can also include an input/output (I/O) module 508 for communicating with an input device (not shown) such as an LCD display, keyboard, or the like for receiving and sending commands to the processors 504. Other input devices can also include those requiring cursor controls, a mouse, a trackball, etc.

For communicating with other devices and/or networks, the client computing device 102 can include a network module 512. Network module 512 can be a module that allows for communication between the device 102 and at least the location server computing device 104 and the network server computing device 108, the current network and secondary backup network. Network module 512 can enable the transmission of information being processed by processors 504 over the air with the aid of the analog front-end (AFE) module 502. AFE module 502 can be a signal conditioning module that enables the transmission and conversion of digital signals into analog signals for channel transmission. The AFE module 502 can include filters, quantizers, amplifiers and even analog to digital converters for interfacing between the network module and the antennas 514.

Antennas 514 can be used for the wireless transmission of signals in instances where the primary and/or backup service is wireless. Antennas 514 on device 102 can be an antenna that can be used for single input single output (SISO) transmission, multiple input single output (MISO) transmission, single input multiple output (SIMO) transmission, or multiple input multiple output (MIMO) transmission as commonly used in cellular communications. The use of multiple antennas 514 can be used to provide increased efficiency and data throughput by taking advantage of spatial and multiplexing diversity. Further, MIMO communications provide increased reliability as the information stream can be sent multiple times over the various antennas in order to overcome possible nulls or deep fades in a channel transmission. Still further, the use of antennas 514 can enable communication over various wireless networks including WLAN, cellular, WMAN, WPAN, etc., including mesh network interconnectivity.

The system set forth in FIG. 5 is but one possible example of a computer system that may employ or be configured in accordance with aspects of the present disclosure. FIG. 5 illustrates a system architecture for signal communication on a device including the client computing device 102. The computer architecture described may contain additional systems for performing additional processes within the client computing device 102. The client computing device 102 can work jointly or independently of the additional systems that can exist within the device, external devices, and/or networks. The components of the client computing device 102 may communicate over any number of networks, including telecommunication networks and wireless networks. Further, it should be noted that the client computing device 102 may include any number of additional or fewer components, including components used to communicate between the components shown. Also, the functionality of the components described below may be applied to two or more components of the system. For example, the application 206 is used for presenting available wireless services opportunities.

For the purpose of promoting an understanding of the principles of the present disclosure, reference is made to the embodiments illustrated in the drawings, and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon executable instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic executable instructions.

The description above includes example systems, methods, techniques, instruction sequences, and/or computer program products that embody techniques of the present disclosure. However, it is understood that the described disclosure may be practiced without these specific details.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A system comprising:
a processor; and
a non-transitory computer-readable medium storing instructions that, when executed by the processor, cause the processor to perform operations comprising:
receiving a representation of a physical location;
transmitting the representation of the physical location to a server;
receiving from the server, a list of networks that provide service at the physical location based on the representation of the physical location;
receiving a selection of a particular network from the list of networks based on a metric; and
establishing a failover to the particular network at the physical location.

2. The system of claim 1, the operations further comprising receiving a geographic region associated with the physical location and receiving from the server the list of networks that provide service within the geographic region associated with the physical location.

3. The system of claim 1, the operations further comprising determining a received signal strength indication (RSSI) for each network in the list of networks and selecting the particular network based on the RSSI.

4. The system of claim 1, the operations further comprising receiving one of an address and latitude/longitude as the representation of the physical location.

5. The system of claim 1, the operations further comprising displaying a graphical user interface (GUI) that shows statistical information for each network in the list of networks.

6. The system of claim 1, the operations further comprising ordering the list of networks in a particular order based on the metric.

7. The system of claim 1, the failover further comprising determining a network outage and transitioning network traffic from a primary network with the network outage to the particular network.

8. A method comprising:
receiving, by a processor, a first representation of a physical location;
transmitting, by the processor, the first representation of the physical location;
receiving, by the processor, a second representation of the physical location that corresponds with the first representation of the physical location;
transmitting, by the processor, the second representation of the physical location to a server;
receiving, by the processor, from the server, a list of cellular networks that provide service at the physical location based on the second representation of the physical location;
receiving, by the processor, a selection of a particular network from the list of cellular networks; and
establishing, by the processor, a failover from a primary network with a network outage to the particular network at the physical location.

9. The method of claim 8, further comprising receiving a geographic region associated with the physical location and receiving from the server the list of cellular networks that provide service within the geographic region associated with the physical location.

10. The method of claim 8, further comprising determining a received signal strength indication (RSSI) for each network in the list of cellular networks and selecting the particular network based on the RSSI.

11. The method of claim 8, further comprising receiving an address as the first representation of the physical location and receiving latitude and longitude as the second representation of the physical location.

12. The method of claim 8, further comprising displaying a graphical user interface (GUI) that shows statistical information for each network in the list of networks.

13. The method of claim 8, further comprising ordering the list of cellular networks in a particular order based on a selected metric.

14. The method of claim 8, further comprising ordering the list of cellular networks in a particular order based on metrics comprising RSSI, cost, throughput, reliability, download speed, upload speed, and ping time

15. A non-transitory computer-readable medium storing instructions that, when executed by a processor, cause the processor to perform operations comprising:
receiving a first representation of a physical location;
transmitting the first representation of the physical location;
receiving a second representation of the physical location that corresponds with the first representation of the physical location;
transmitting the second representation of the physical location to a server;
receiving from the server, a list of cellular networks that provide service at the physical location based on the second representation of the physical location;
receiving a selection of a particular network from the list of cellular networks; and
establishing a failover from a primary network with a network outage to the particular network at the physical location.

16. The non-transitory computer-readable medium of claim 15, the operations further comprising receiving a geographic region associated with the physical location and receiving from the server the list of networks that provide service within the geographic region associated with the physical location.

17. The non-transitory computer-readable medium of claim 15, the operations further comprising determining a received signal strength indication (RSSI) for each network in the list of networks and selecting the particular network based on the RSSI.

18. The non-transitory computer-readable medium of claim 15, the operations further comprising receiving an address as the first representation of the physical location and receiving latitude and longitude as the second representation of the physical location.

19. The non-transitory computer-readable medium of claim 15, the operations further comprising displaying a graphical user interface (GUI) that shows statistical information for each network in the list of networks.

20. The non-transitory computer-readable medium of claim 15, the operations further comprising ordering the list of networks in a particular order based on a selected metric.
